(19) United States
(12) Patent Application Publication
(10) Pub. No.: US 2015/0205498 A1
(43) Pub. Date: Jul. 23, 2015

(54) AUTOMATIC WALLPAPER IMAGE CHANGER FOR A COMPUTING DEVICE

(71) Applicant: Southern Telecom Inc., Brooklyn, NY (US)

(72) Inventor: Alan I. Levi, Brooklyn, NY (US)

(21) Appl. No.: 14/598,939

(22) Filed: Jan. 16, 2015

Related U.S. Application Data
(60) Provisional application No. 61/928,645, filed on Jan. 17, 2014.

(51) Int. Cl. G06F 3/0484; G06F 17/30; G06F 3/0481

(52) U.S. Cl. CPC G06F 3/04842; G06F 3/04817; G06F 17/30244

(57) ABSTRACT

A method and computing device provide support for automatically changing wallpaper images that are displayed via a user interface of a computing device. A single icon is displayed via the user interface that is associated with automatically changing the wallpaper displayed by the user interface. A single input from the user is received when the user engages the single icon displayed via the user interface to automatically change the wallpaper displayed by the user interface. A current wallpaper image that is displayed by the user interface is replaced with an updated wallpaper image when the input from the user is received.

### CROSS-REFERENCE TO RELATED APPLICATIONS

This application is a U.S. Non-provisional application which claims the benefit of U.S. Provisional Application No. 61/928,645 filed on Jan. 17, 2014, which is incorporated herein by reference in its entirety.

### FIELD OF THE INVENTION

The invention is generally related to wallpaper images displayed on a computing device, and in particular to computing devices and methods utilized therein.

### BACKGROUND OF THE INVENTION

A wallpaper image, which may also be referred to as a desktop image or a background image, is an image used as a background and/or a screensaver on a computing device, such as a desktop computer, laptop, and/or mobile communications device. The wallpaper image may be a design and/or a photographic image that is displayed to the user in the background, desktop, lock screen or home screen of the computing device as the user operates the computing device. The wallpaper image may be stored on the computing device and/or retrieved from a location external to the computing device, such as a database. The wallpaper image may be a default image provided by the manufacturer of the computing device and/or a personal image provided by the user to be displayed in the background.

The wallpaper image may be displayed to the user when the user has all programs either closed and/or minimized so that only the background of the computing device is displayed to the user. Running programs that are maximized may be layered on top of the background so that the wallpaper image is not displayed to the user. In addition, in some instances, icons used to run applications and other user controls may be overlaid on a wallpaper image. The wallpaper image may also be displayed to the user as a screensaver. The screensaver is displayed to the user after the computing device has been unused by the user for a period of time so that only the screensaver is displayed until the user re-engages the computing device. Conventionally, changing the wallpaper image that is displayed to the user either as the background or the screensaver requires the user to complete several steps to change the wallpaper image. Typically, the user has to go through a series of menus provided by the operating system of the computing device to select a new wallpaper image and then replace the current wallpaper image that is displayed to the new wallpaper image.

In many instances, the user has several wallpaper images stored on the computing device that the user has a personal interest in such as different images depicting family members that the user takes comfort in when viewing. The user may like to view these personal wallpaper images as the user engages the computing device rather than viewing a single wallpaper image until the user completes the steps necessary to change the wallpaper image. Having to complete the necessary steps by the user to change the wallpaper image may be time consuming and be a burden to the user. Furthermore, particularly for computing devices targeted at young children, the steps necessary to change a wallpaper image may be beyond a child's capabilities.

A need therefore continues to exist in the art for an improved manner of changing the wallpaper images displayed by a computing device.

### SUMMARY OF THE INVENTION

The invention addresses these and other problems associated with the prior art by providing a method and computing device that automatically change wallpaper images that are displayed by a computing device in response to a single user input. In many embodiments consistent with the invention, a graphical user interface control, e.g., a single icon, is displayed to the user. The user may engage the single icon by clicking and/or touching the single icon when the user requests to automatically change the wallpaper image displayed by the computing device. After engaging the single icon, the wallpaper image currently displayed to the user may be automatically replaced with a different wallpaper image that is displayed to the user, and without further input from the user.

Therefore, consistent with one aspect of the invention, a computing device includes a user interface that is configured to display a single icon that is associated with automatically changing the wallpaper displayed by the user interface. Program code is configured for execution by at least one processor to receive a single input from a user when the user engages the single icon displayed via the user interface to automatically change the wallpaper image displayed by the user interface. The program code is also configured to replace a current wallpaper image that is displayed by the user interface with an updated wallpaper when the single input from the user is received.

Further features and advantages of the invention, as well as the structure and operation of various embodiments of the invention, are described in detail below with reference to the accompanying drawings. The invention is not limited to the specific embodiments described herein. The embodiments are presented for illustrative purposes only and so that readers will have multiple views enabling better perception of the invention, which is broader than any particular embodiment. Additional embodiments will be apparent to persons skilled in the relevant art(s) based on the teachings set forth in this patent document.

### BRIEF DESCRIPTION OF THE DRAWINGS

The accompanying drawings, which are incorporated herein and form part of the specification, illustrate the present invention and, together with the description, further serve to explain the principles of the present invention and to enable a person skilled in the pertinent art to make and use the present invention. Various embodiments of the present invention are described below with reference to the drawings, wherein like reference numerals are used to refer to like elements throughout.

FIG. 1 shows an exemplary automatic wallpaper image changing network environment, in accordance with embodiments of the present invention.

FIG. 2 shows a flow chart illustrating a method for automatically changing wallpaper images that are displayed to a user via a user interface, in accordance with embodiments of the present invention.

FIG. 3 shows an exemplary wallpaper image computing device for allowing the user to automatically change wallpaper images that are displayed via the user interface of the computing device, in accordance with embodiments of the present invention.

FIG. 4 shows a flow chart illustrating a method for modifying the wallpaper images that are displayed by an exemplary wallpaper image computing device, in accordance with embodiments of the present invention.

FIG. 5 shows an exemplary wallpaper image computing device for modifying the wallpaper images that are to be displayed to the user by the user interface, in accordance with embodiments of the present invention.

FIG. 6 shows an exemplary computer system in which embodiments of the present invention, or portions thereof, may be implemented as computer-readable code.

### DETAILED DESCRIPTION

Embodiments consistent with the invention facilitate automatic changing of wallpaper images displayed to a user by a computing device, rather than having the user complete multiple steps required by the operating system of the computing device to change the wallpaper images. Wallpaper images are generally images that are displayed to the user by the computing device behind any active programs running on a computing device. For example, wallpaper images are images that are displayed to the user by the computing device when the user has all programs supported by the computing device closed and/or all open programs in a minimized state so that the program is not actively being displayed to the user by the computing device. In some instances, icons and other graphical user interface controls may be displayed on top of a wallpaper image, e.g., when the wallpaper image is serving as a desktop, lock screen or home screen image, and in some instances, open programs may only overlap a portion of a display such that portions of a wallpaper image are still displayed. Where open programs are set to run in a full screen mode, or where all overlapping open programs cover the entire display area, a wallpaper image may be completely hidden from a user. In addition, while the wallpaper images discussed hereinafter are static images, it will be appreciated that wallpaper images may also be animated or may incorporate motion video, so the invention is not limited to static wallpaper images.

Traditionally operating systems of computing devices require the user to complete several steps in changing the wallpaper images displayed by the computing device. For example, a typical method of changing wallpaper images using the operating system of the computing devices requires that the following steps be completed by the user. First, the user is required to select a “settings” option or app provided by the operating system. The “settings” option provides the user the opportunity to change several options that affect the performance of the computing device. Typical example settings include, Wi-Fi settings, Bluetooth settings, data usage settings, sound settings, display settings, wallpaper image settings, LED indicator settings and so on. The “settings” option may typically be selected by the user via an icon displayed by the computing device and/or a menu option provided by the computing device.

After the user has opened up the “settings” option, the second step requires the user to select the wallpaper image option listed in the “settings” option. Some settings may also be hierarchically organized such that a user is required to navigate through multiple steps, menus or displays prior to viewing the wallpaper image option. After the user has selected the wallpaper image option, the third step requires the user to select which wallpaper image option that the user would like to adjust. The wallpaper image option typically includes several wallpaper image options. For example, a “background screen” option allows the user to adjust the wallpaper image options associated with the background, lock screen, home screen or desktop of the computing device.

In another example, a “screensaver screen” option allows the user to adjust the wallpaper image options associated with the screensaver of the computing device. The screensaver of the computing device is displayed to the user by the computing device when the user has not engaged the computing device for a period of time. After a period of time expires without any interaction by the user with the computing device, the computing device may enter a screensaver mode where the computing device displays wallpaper images associated with the screensaver mode. The computing device then terminates the display of the wallpaper image associated with the screensaver mode when the user re-engages the computing device. In another example, a “background screen and screensaver screen” option allows the user to adjust the wallpaper image options associated with both the background and the screensaver of the computing device.

After the user has selected which wallpaper image option that the user would like to address, the fourth step is to select a location of where the replacement wallpaper image is to be taken from. For example, the user may select wallpaper images from a “gallery” of wallpaper images that are generic images provided by the computing device. The “gallery” of wallpaper images are generic images that are loaded onto the computing device by the manufacturer before the computing device is offered for sale to the user. In another example, the user may select wallpaper images from “photos” of wallpaper images that are personal photographic images installed onto the computing device by the user. The user may install their own photographic images and/or any other image onto the computing device to be displayed as wallpaper images. After the user has selected the source of where the replacement wallpaper image is to be taken from, the fifth step requires that the user finally select the wallpaper image that the user requests to currently be displayed by the computing device.

The example multi-step process that operating systems of computing devices typically require from the user to change the wallpaper images displayed by the computing device is cumbersome and time consuming for the user. The user may have a large quantity of personal photographic images stored on the computing device that the user requests to view. Simply displaying a static image until the user completes the multi-step process to change the wallpaper images burdens the user who requests to view their personal photographic images at a faster rate. However, setting up a sequence of wallpaper images to be displayed to the user by the computing device at specified time intervals does not provide the user the control to change wallpaper images when the user requests to do so. The user may want to view specific wallpaper images for longer durations than others. As a result, a sequence may not display specific wallpaper images to the user for a long enough duration to satisfy the user while other wallpaper images may be displayed to the user longer than the user would like.

In contrast with conventional approaches, embodiments consistent with the invention provide freedom to the user to change the wallpaper images displayed by the computing device when the user requests to change the wallpaper images while condensing the steps required by the user to change the wallpaper images to a single input or step. In some embodiments, a single icon is displayed to the user by the computing device. The user may simply and in a single input engage the single icon such as by clicking the icon and/or touching the icon to change the wallpaper image displayed by the computing device when the user requests to change the wallpaper image. After engaging the single icon, the computing device replaces the wallpaper image that was previously displayed by the computing device to a different wallpaper image. The computing device may then continue to display the replacement wallpaper image until the user again engages the single icon to display another wallpaper image by the computing device.

In the detailed description that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The term “embodiments of the invention” does not require that all embodiments of the invention include the discussed feature, advantage or mode of operation. Alternate embodiments may be devised without departing from the scope of the invention, and well-known elements of the invention may not be described in detail or may be omitted so as not to obscure the relevant details of the invention. In addition, the terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

In addition, functionality associated with the various embodiments disclosed herein may be described in terms of being implemented in modules. A module, in this regard, may include hardware, software, firmware or a combination thereof implementing the described functionality. Software may include one or more applications and an operating system. Hardware can include, but may not be limited to, a processor, memory, and/or graphical user display. A module may be any type of processing (or computing device) having one or more processors. For example, a module can be an individual processor, workstation, mobile device, computer, cluster of computers, set-top box, game console or other device having at least one processor. Moreover, it will be appreciated that the functionality of a module may be implemented by multiple modules in some embodiments, and that the functionality of multiple modules may be combined into a common module in some embodiments. Therefore, the invention is not limited to the particular organization of modules described herein.

### Hardware and Software Environment

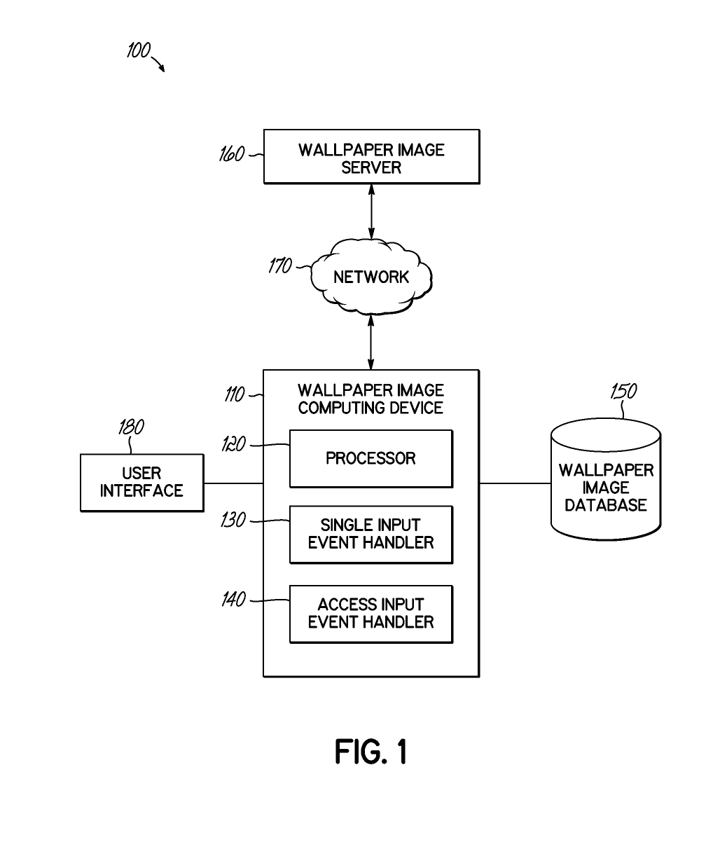

FIG. 1 shows an illustration of an automatic wallpaper image changing network environment 100 according to the present invention. Automatic wallpaper image changing network environment 100 includes a wallpaper image computing device 110, a wallpaper image database 150, a user interface 180, a network 170, and a wallpaper image server 160. Wallpaper image computing device 110 includes a processor 120, a single input event handler 130, and an access input event handler 140.

A user may request to change a wallpaper image displayed by user interface 180 for wallpaper image computing device 110, e.g., a background image, a screensaver image, a desktop image, a home screen image, a lock screen image and/or any other image that is displayed by user interface 180 of wallpaper image computing device 110 separate from an active program that will be apparent to those skilled in the relevant art(s) without departing from the spirit and scope of the present disclosure. The wallpaper image may include a design, a pattern, a photographic image, and/or any other image that may be displayed as a wallpaper image to the user that will be apparent those skilled in the relevant art(s) without departing from the spirit and scope of the present disclosure.

User interface 180 may provide an operator the ability to interact with wallpaper image computing device 110. User interface 180 may be any type of display device but not limited to a touch screen display, a liquid crystal display (LCD) screen, and/or any other type of display that will be apparent from those skilled in the relevant art(s) without departing from the spirit and scope of the present disclosure.

User interface 180 may be displaying a current wallpaper image to the user. The user may reach a point where the user requests to change the current wallpaper image displayed by user interface 180 to a different wallpaper image. However, the user does not want to go through the series of steps required by the operating system to change the wallpaper image. The user also does not want to turn on a sequence of wallpaper images where each wallpaper image is displayed for a period of time and then a subsequent wallpaper image is displayed for a period of time and so on. The user simply wants to automatically replace the current wallpaper image with a different wallpaper image.

The user may instead engage a single icon displayed by user interface 180 to automatically change the current wallpaper image displayed by user interface 180. The user may engage the single icon when the user requests to change the current wallpaper image displayed by user interface 180 to a different wallpaper image. The user may click, touch, and/or any other technique to engage the single icon that will be apparent to those skilled in the relevant art(s) without departing from the spirit and scope of the present disclosure.

The single input generated by the user when the user engages the single icon may generate an event that is an action or occurrence detected by single input event handler 130. In conventional approaches, the sequence of wallpaper images where each wallpaper image is displayed for a period of time and then a subsequent wallpaper image is displayed for a period of time and so on is generated by the conventional operating system as synchronous events. In such a conventional approach, the display of the sequence of wallpaper images is handled by the operating system as an event loop where each wallpaper image is displayed for the specified period of time in sequence.

However, the single input generated by the user when the user engages the single icon with the intent of automatically changing the current wallpaper image displayed by user interface 180 can occur at any instant, with any length of period of time between generated single inputs, as well as the user continuing to generate the single input until user interface 180 displays the wallpaper image that satisfies the user. Thus, wallpaper image computing device 110 may respond to the event of the single input generated by the user rather than synchronously performing operations as in conventionally displaying each wallpaper image in sequence for a specified period of time.

In order to accommodate the instantaneous events of the user engaging the single icon to generate the single input, single input event handler 130 may receive the single input generated by the user each time the user has the intent of changing the current wallpaper image displayed by user interface 180. Processor 120 may collect data associated with the single input generated by the user engaging the single icon, such as the period of time that the user engages the single icon. Based on that data, processor 120 may determine that the user is requesting that the wallpaper image displayed by user interface 180 be automatically changed to another wallpaper image. Processor 120 may then transfer the single input to single input event handler 130. Single input event handler 130 may then automatically change the wallpaper image displayed by user interface 180 based on the single input.

The user may also request to modify the wallpaper images that may be automatically displayed by user interface 180, such as add additional images that may be automatically displayed by user interface 180. To do so, the user may continue to engage the single icon. Rather than generate a single input when engaging the single icon, the user may generate an access input when engaging the single icon. The access input may be indicative that the user requests to modify the wallpaper images automatically displayed by user interface 180 rather than automatically change the wallpaper image displayed by user interface 180.

In order to distinguish the single input generated by the user engaging the single icon from the access input, the actual engagement of the single icon by the user may differ when the user generates the single input from when the user generates the access input. For example, the user may single click the single icon when the user requests to automatically change the wallpaper image displayed by user interface 180 and then double click the single icon when the user requests to modify the wallpaper images displayed by user interface 180. The difference in the engagement of the single icon by the user to generate the single input as opposed to the access input may differ in quantity of clicks, the period of time in which the user engages user interface 180, the pressure applied by the user as the user engages user interface 180, and/or any other technique that can differentiate when the single input is generated as opposed to when the access input is generated that will be apparent to those skilled in the relevant art(s) without departing from the spirit and scope of the present disclosure.

In order to accommodate the instantaneous events of the user engaging the single icon to generate the access input, access input event handler 140 may receive the access input generated by the user each time the user has the intent of modifying the wallpaper images displayed by user interface 180. Processor 120 may collect data associated with the engagement of the single icon by the user. Based on that data, processor 120 may distinguish that the user is requesting to modify the wallpaper images displayed by user interface 180 rather than requesting to automatically change the wallpaper image displayed by user interface 180. Processor 120 may then transfer the access input to the access input event handler 140. Access input event handler 140 may then provide access to the wallpaper images displayed by user interface 180 to the user for the user to modify based on the access input.

In an embodiment, the wallpaper images may be stored in wallpaper image database 150, which may be resident on or remote to wallpaper image computing device 110. In other embodiments, the wallpaper images may simply be stored in a file system, e.g., in a dedicated folder or directory. In other embodiments, the wallpaper images may be stored in wallpaper image server 160 that may be remote to wallpaper image computing device 110 in that wallpaper image server 160 updates the wallpaper images stored in wallpaper image database 150 via network 170. The wallpaper images may therefore be stored on wallpaper image computing device 110, wallpaper image database 150 that is resident or remote to wallpaper image computing device, on wallpaper image server 160 remote to wallpaper image computing device 110, a cloud, and/or any other storage location capable of providing the wallpaper images to be displayed by user interface 180 that will be apparent to those skilled in the relevant art(s) without departing from the spirit and scope of the present disclosure.

One or more wallpaper image computing devices 110 may connect to one or more wallpaper image servers 160 via network 170. Wallpaper image computing device 110 is typically a device that includes a processor, a memory, and a network interface, hereinafter referred to as a computing device or simply “computer.” For example, wallpaper image computing device 110 may include a mobile telephone, a smartphone, a workstation, a portable computing device, other computing devices such as a personal, a laptop, or a desktop computer, cluster of computers, and/or any other suitable computing device with a user interface that can display wallpaper images that will be apparent to those skilled in the relevant art(s) without departing from the spirit and scope of the present disclosure. In an embodiment, multiple modules may be implemented on the same computing device. Such a computing device may include software, firmware, hardware, or a combination thereof. Software may include one or more applications on an operating system. Hardware can include, but is not limited to, a processor, memory, and/or graphical user interface display.

In an embodiment, wallpaper image server 160 may stream wallpaper images to wallpaper mage computing device 110 via network 120. Network 120 includes one or more networks, such as the Internet. In some embodiments of the present invention, network 120 may include one or more wide area networks (WAN) or local area networks (LAN). Network 120 may utilize one or more network technologies such as Ethernet, Fast Ethernet, Gigabit Ethernet, virtual private network (VPN), remote VPN access, a variant of IEEE 802.11 standard such as Wi-Fi, and the like. Communication over network 120 takes place using one or more network communication protocols including reliable streaming protocols such as transmission control protocol (TCP). These examples are illustrative and not intended to limit the present invention.

Wallpaper image server 160 may be any type of processing (or computing device) as described above. For example, wallpaper image computing device 110 may be a workstation, mobile device, computer, cluster of computers, set-top box, or other computing device. In an embodiment, multiple modules may be implemented on the same computing device. Such a computing device may include software, firmware, hardware, or a combination thereof. Software may include one or more applications on an operating system. Hardware can include, but is not limited to, a processor, memory, and/or graphical user interface display.

Wallpaper image server 160 may also include a conventional web server, e-mail server, or file transfer server configured to provide functions of the various embodiments of the present disclosure.

Wallpaper image computing device 110, wallpaper image server 160, and wallpaper image database 150 may share resources via network 120. For example, wallpaper image server 160 may provide wallpaper images to wallpaper image computing device 110 that are stored on wallpaper image database 150. Wallpaper image computing device 110 may also retrieve wallpaper images from wallpaper image database 150 and provide those wallpaper images to wallpaper image server 160. Based on the cloud computing configuration, the interaction between wallpaper image computing device 110, wallpaper image server 160, and wallpaper image database 150 may not be limited to a single computing device. For example, a plurality of computing devices may update wallpaper image database 150 with wallpaper images.

### Automatic Changing of a Wallpaper Image

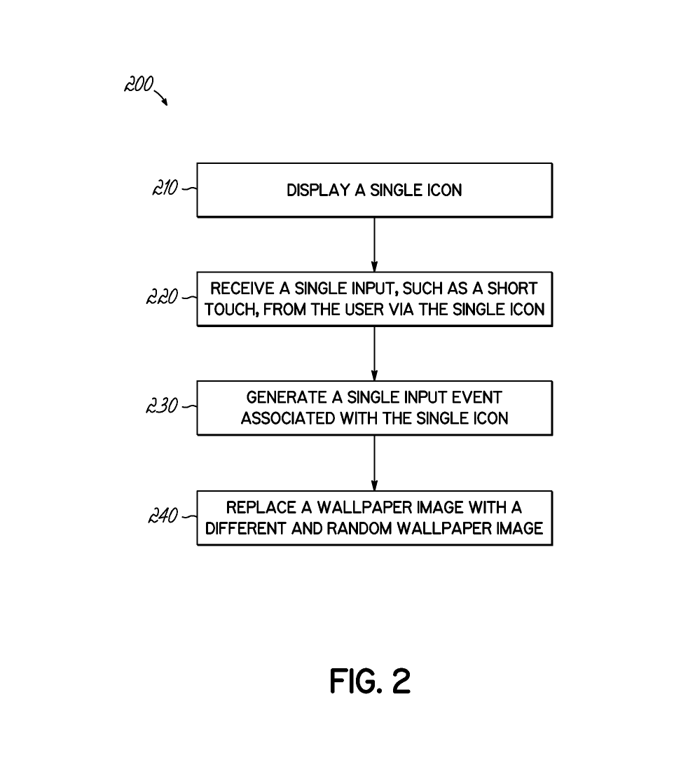

Embodiments consistent with the invention allow the user to automatically change a wallpaper image displayed to the user by user interface 180 for wallpaper image computing device 110. One such implementation of allowing the user to automatically the change wallpaper image, is illustrated by process 200 in FIG. 2.

Process 200 includes four primary steps: display a single icon 210, receive a single input, such as a short touch, from the user via the single icon 220, generate a single input event associated with the single icon 230, and replace a wallpaper image with a different wallpaper image 240, each of which will be discussed in greater detail below. Steps 210-240 are typically implemented in a computer, such as wallpaper image computing device 110, via software and/or hardware.

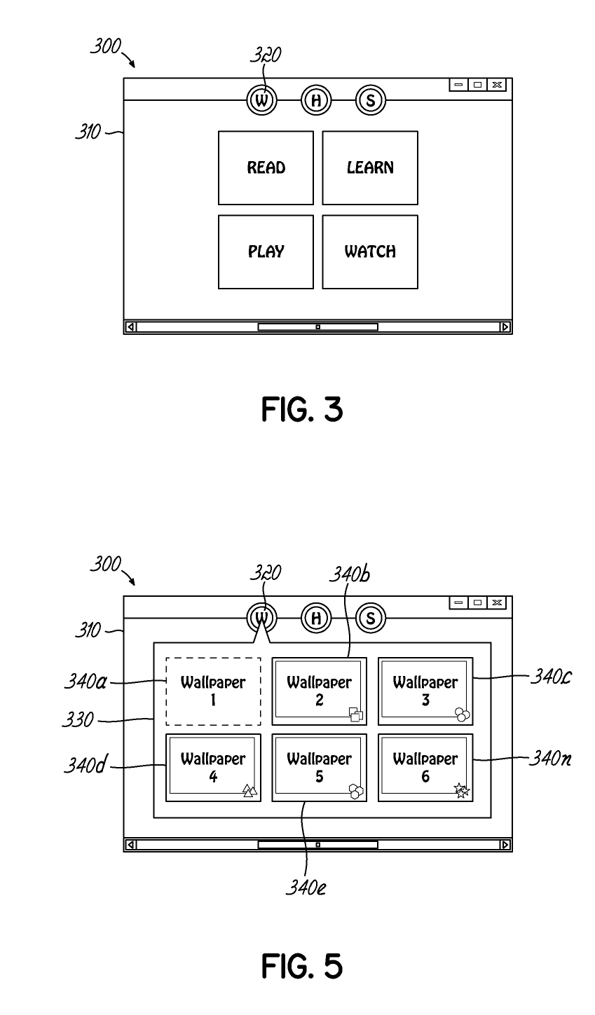

In step 210, a single icon may be displayed via the user interface that is associated with automatically changing a wallpaper image displayed by the user interface. For example in FIG. 3, wallpaper image computing device 300 includes a user interface 310 and a single icon 320. User interface 310 may display single icon 320 to the user. Single icon 320 may be associated with automatically changing a wallpaper image displayed by user interface 310. The user may be engaging wallpaper image computing device 300 where wallpaper image computing device 300 is displaying the wallpaper image.

User interface 310 may be displaying a current wallpaper image to the user. The user may reach a point where the user requests to change the current wallpaper image displayed by user interface 310 to a different wallpaper image. However, the user does not want to go through the series of steps required by the operating system to change the wallpaper image. The user also does not want to turn on a sequence of wallpaper images where each wallpaper image is displayed for a period of time and then a subsequent wallpaper image is displayed for a period of time and so on. The user simply wants to automatically replace the current wallpaper image with a different wallpaper image.

In step 220, a single input from the user is received when the user engages single icon 320 displayed via user interface 310 to automatically change the current wallpaper image displayed by user interface 310. The user may engage single icon 320 when the user requests to change the current wallpaper image displayed by user interface 310 to a different wallpaper image. As noted above, the user may engage single icon 320 when requesting different tasks be executed by wallpaper image computing device 310. For example, the user may engage single icon 320 to automatically change the current wallpaper image displayed by user interface 310. The user may also engage single icon 320 to modify the wallpaper images that may be displayed by user interface 310.

As a result, the single input received from the user may be associated with a type of input that may be interpreted by wallpaper image computing device 310 as a request to automatically change the wallpaper image. The type of input associated with the single input would then differ from any other inputs received by the user that may be associated with requests for other tasks to be executed by wallpaper image computing device 310. For example, the single input may be a short input in that the period of time in which the user engages single icon 320 on user interface 310 is a shorter period of time as compared to the periods of time in which the user engages single icon 320 for other tasks. In another example, the single input may be single click in that the user engages single icon 320 with a single touch as compared to multiple clicks in which the user engages single icon 320 with multiple touches in succession.

Wallpaper image computing device 310 may then process the data associated with the single input received from the user in which the data includes the type of input received from the user. For example, a short touch input received from the user is associated with automatically changing the wallpaper image displayed by user interface 310. Wallpaper image computing device 310 may then process that short touch input as being associated with a request by the user to automatically change the wallpaper image displayed by user interface 310.

In step 230, a short touch event associated with single icon 320 may be generated. As noted above, the single input received from the user may happen at any time and at any period of times between the generations of single inputs that conventional synchronous methods of displaying the wallpaper images in sequence are inadequate to handle the asynchronous nature of the single input generation by the user. Thus, wallpaper image computing device 310 provides an interactive environment in which the user may automatically change the wallpaper image displayed by user interface 310 instantaneously after the user engages single icon 320 with the single input such as the short touch.

In providing the interactive environment, wallpaper image computing device 310 may generate a short touch event after determining that the single input received by the user, such as the short touch, is associated with a request by the user to automatically change the wallpaper image. The short touch event may then be handled by single input event handler 130 in which single input event handler 130 includes instructions to execute after receiving a single input, such as a short touch. Specifically, single input event handler 130 includes instructions as to how to automatically change the wallpaper image displayed by user interface 310 after being notified by wallpaper image computing device 310 that the user has indeed requested such instructions be executed.

In step 240, the current wallpaper that is displayed by user interface 310 may be replaced with an updated and random wallpaper image when the single input from the user is received. After the user engages single icon 320 triggering the input associated with the user's request to automatically replace the current image displayed by user interface 310 with the updated wallpaper image, the current wallpaper image is instantly replaced by the updated wallpaper image. The user does not have to go through a series of steps to change the wallpaper image displayed by user interface 310. Rather, the user may simply engage single icon 320 and the current wallpaper image may be automatically replaced by the updated wallpaper image. The user may then repeat process 200 each time that the user requests to change the wallpaper image displayed by user interface 310.

The updated wallpaper image may be selected from a plurality of wallpaper images previously installed on wallpaper image computing device 300 when the input from the user is received. Each wallpaper image available to be displayed by user interface 310 may be previously installed on wallpaper image computing device 300, or otherwise added to a set of wallpaper images in the computing device. For example, wallpaper images may include generic images loaded onto wallpaper image computing device 300 by the manufacturer before wallpaper image computing device 300 was offered for sale to the user. Wallpaper images may also include personal images installed onto wallpaper image computing device 300 by the user. For example, the user may install several photographic images on wallpaper image computing device 300 that the user requests to be displayed as wallpaper images by user interface 310. Wallpaper images may be installed onto wallpaper image computing device 300 as generic images, personal images, and/or any other source of images that may be previously installed onto wallpaper image computing device 300 as wallpaper images that will be apparent to those skilled in the relevant art(s) without departing from the spirit and scope of the present disclosure.

The updated wallpaper image may be randomly selected from the plurality of wallpaper images previously installed on wallpaper image computing device 300. Each time the user engages single icon 320 to change the current wallpaper image that is displayed by user interface 310 to a different wallpaper image, the updated wallpaper image that replaces the current wallpaper image may be randomly selected. In an embodiment, each wallpaper image previously installed in wallpaper image computing device 300 may be assigned a number. A random number generator may randomly select a number assigned to a stored wallpaper image when the user engages single icon 320 to change the current wallpaper image to a different wallpaper image. The updated wallpaper image selected to replace the current wallpaper image may be selected based on the number assigned to the selected updated wallpaper image matches the number generated by the random number generator. Thus, the updated wallpaper image may be randomly selected and then displayed when the user engages single icon 320. In other embodiments, wallpaper images may be selected in a predetermined order.

### Modify the Wallpaper Images Displayed

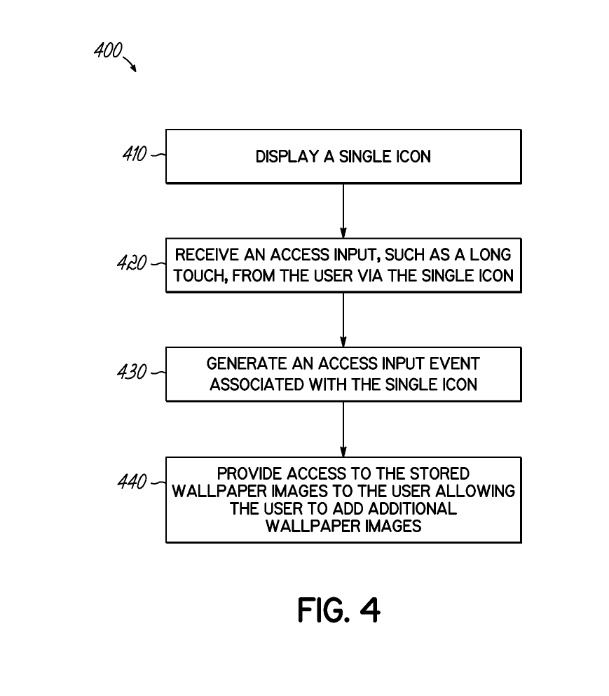

Embodiments consistent with the invention allow the user to modify the wallpaper images displayed by wallpaper image computing device 200. One such implementation of allowing the user to modify the wallpaper images displayed by wallpaper image computing device 300, is illustrated by process 400 in FIG. 4.

Process 400 includes four primary steps: display a single icon 410, receive an access input, such as a long touch from the user via the single icon 420, generate an access input event associated with the single icon 430, and provide access to the stored wallpaper images to the user allowing the user to add additional wallpaper images 440. Steps 410-440 are typically implemented in a computer, such as wallpaper image computing device 110, via software and/or hardware.

In step 410, a single icon may be displayed via the user interface that is associated with modifying the wallpaper images displayed by the wallpaper imaging device by the user. For example in FIG. 5, wallpaper image computing device 300 includes a user interface 310 and single icon 320. Single icon 320 implemented to automatically change the wallpaper images displayed by user interface 310 is the same icon implemented to modify the wallpaper images displayed by wallpaper image computing device 300. Thus, single icon 320 may be associated with modifying the wallpaper images displayed on wallpaper image computing device 310 as well as automatically changing a wallpaper image displayed by user interface 310.

Wallpaper image computing device 310 may be storing specific wallpaper images and thus any display of wallpaper images by user interface 310 may be limited to those stored wallpaper images. The user may request that additional wallpaper images be displayed by user interface 310 and/or that specific wallpaper images no longer be displayed by user interface 310. Thus, the user may modify the wallpaper images that may be displayed by user interface 310 by modifying the wallpaper images displayed by wallpaper image computing device 310 by engaging single icon 320.

In step 420, the user may engage single icon 320 to modify the wallpaper images displayed on wallpaper image computing device 300 by generating an access input when engaging single icon 320. The access input associated with modifying the wallpaper images displayed on wallpaper image computing device 300 may differ from the single input associated with automatically changing the wallpaper images displayed by user interface 310. In order to distinguish whether the user requests to change the wallpaper images or modify the wallpaper images, the user may engage single icon 320 with two different types of engagements. Each different type of engagement may then generate a different input that is received.

For example, the user may engage single icon 320 with a first engagement, e.g., a short touch or single click, when the user requests to change the wallpaper image that is displayed. The first engagement generates the single input that is received and provides instruction to automatically replace the current wallpaper image with the updated wallpaper image. The user may then engage single icon 320 with a second engagement, e.g., a long touch or a double click, when the user requests to modify the wallpaper images. The second engagement generates an access input that is received and provides instruction to provide the user the capability to edit the wallpaper images. In many embodiments, the operating system of the computing device may distinguish from among different events and call event handlers that have registered to handle those events. Thus, in some embodiments, one event handler may be associated with a short touch or single click event for icon 320 to handle user requests to change the wallpaper image that is displayed, and another event handler may be associated with a double click or long touch event for icon 320 to handle user requests to modify the wallpaper images.

The first engagement may include the user touching single icon 320. The touching of single icon 320 may generate the single input that is received and provides instruction to automatically replace the current wallpaper image with the updated wallpaper image. The second engagement may include pressing and holding single icon 320. The pressing and holding of single icon 320 may generate an access input that is received and enables the user to modify the wallpaper images. Any type of engagements that adequately differentiate from each other to generate the single input and/or the access input may be used as will be apparent to those skilled in the relevant art(s) without departing from the spirit and scope of the present disclosure.

Wallpaper image computing device 310 may then process the data associated with the access input received from the user in which the data includes the type of input received from the user. For example, a short touch input received from the user is associated with automatically changing the wallpaper image displayed by user interface 310 while a long touch input received from the user is associated with modifying the wallpaper images displayed by wallpaper image computing device. Wallpaper image computing device 310 may analyze the period of time that the user engages single icon 320.

Wallpaper image computing device 310 may determine that the user generated a short touch when the user engages single icon 320 for a period of time that is less than a threshold level of time. Wallpaper image computing device 310 may determine that the user generated a long touch when the user engages single icon 320 for a period of time that is greater than the threshold level of time. Wallpaper image computing device 310 may then process that long touch input as being associated with a request by the user to modify the images displayed by wallpaper image computing device 310 when the period of time the user engages single icon 320 exceeds the threshold level of time.

In step 430, an access input event associated with single icon 320 may be generated. Wallpaper image computing device 310 may generate an access input event after determining that the access input received from the user, such as the long touch, is associated with a request by the user to modify the wallpaper images displayed by wallpaper image computing device 310. The long touch event may then be handled by access input event handler 140 in which access input event handler 140 includes instructions to execute after receiving an access input, such as a long touch. Specifically, access input event handler 140 includes instructions as to enable the user to modify the wallpaper images displayed by wallpaper image computing device 310 after being notified by wallpaper image computing device 310 that the user has indeed requested such instructions be executed.

In step 440, access may be provided to the stored wallpaper images by the user allowing the user to add additional wallpaper images. FIG. 5 depicts user interface 310 displaying a plurality of wallpaper images 340(a-n), where n is an integer greater than or equal to one. User interface 310 displays dialog window 330 that displays all available wallpaper images 340(a-n) to the user for the user to examine. Dialog window 330 may display at least a subset of the wallpaper images 340(a-n) that are either stored on wallpaper image computing device 300 and/or any other location where wallpaper images 340(a-n) may be retrieved from and displayed by user interface 310. Dialog window 330 may display wallpaper images 340(a-n) in a scrollable list to the user. User interface 310 displays dialog window 330 after the user engaged single icon 320 with the second engagement that generated the access input. After the access input is received, user interface 310 displays dialog window 330 with wallpaper images 340(a-n) so that the user may edit wallpaper images 340(a-n).

The user may access wallpaper images 340(a-n) to scroll through wallpaper images 340(a-n) and determine whether any edits to wallpaper images 340(a-n) may be required and/or any settings associated with wallpaper images 340(a-n) may be required. The user may also select a wallpaper image 340(a-n) that the user requests to be displayed by user interface 310. The user may also add additional wallpaper images to be included in wallpaper images 340(a-n) from dialog window 330. For example, the user may engage wallpaper image 340a which is a blank image by touching or clicking on wallpaper image 340a, representing an add input. The user may then browse for an additional wallpaper image to install into dialog window 330 so that the additional wallpaper image may then be available to be randomly selected as an updated wallpaper image and displayed to the user by user interface 310.

The program code executed by at least one process included in wallpaper image computing device 300 may be configured to execute the above method and technical details. The program code may be incorporated into user interface 310 in that the program code may be installed onto wallpaper image computing device 300 and is part of the operating system of wallpaper image computing device 300. At that point, the program code may be embedded in the operating system so that the user engages the operating system when the user engages the single icon 320 to change the wallpaper image displayed by user interface 310. The program code may also be introduced onto wallpaper image computing device 300 as a widget and/or application where the program code is executed from the widget and/or application and is not part of the operating system of wallpaper image computing device 300. At that point, the program code is independent from the operating system of wallpaper image computing device 300 so that the user engages the widget and/or application when the user engages single icon 320 to change the wallpaper image displayed by user interface 310.

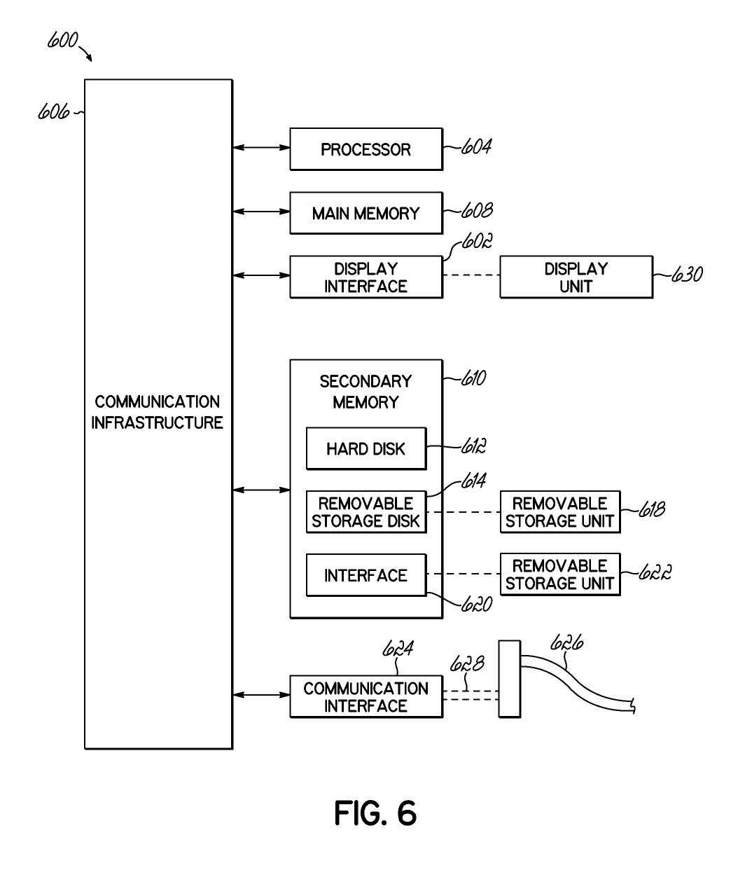

FIG. 6 illustrates an example computer system 600 in which embodiments of the present invention, or portions thereof, may be implemented as computer-readable code. For example, wallpaper image computing device 100, 300 may be implemented on computer system 600 using hardware, software, firmware, tangible computer readable media having instructions stored thereon, or a combination thereof and may be implemented in one or more computer systems or other processing system.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

Various embodiments of the invention are described in terms of this example computer system 600. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As will be appreciated by persons skilled in the relevant art, a computing device having at least one processor device, such as processor device 604, where the processor device may be a single processor, a plurality of processors, a processor in a multi-core/multiprocessor system, such system operating alone, or in a cluster of computing devices operating in a cluster or server farm. Processor device 604 is connected to a communication infrastructure 606, for example, a bus, message queue, network, or multi-core message-passing scheme.

Computer system 600 also includes a main memory 608, for example, random access memory (RAM), and may also include a secondary memory 610. Secondary memory 610 may include, for example, a hard disk drive 612, removable storage drive 614. Removable storage drive 614 may include a floppy disk drive, a magnetic tape drive, an optical disk drive, a flash memory, or the like. The removable storage drive 614 reads and/or writes to a removable storage unit 618 in a well-known manner. Removable storage unit 618 may include a floppy disk, magnetic tape, optical disk, etc. which is read by and written to by removable storage drive 614. As will be appreciated by persons skilled in the relevant art, removable storage unit 618 includes a computer readable storage medium having stored therein computer software and/or data.

In alternative implementations, secondary memory 610 may include other similar means for allowing computer programs or other instructions to be loaded into computer system 600. Such means may include, for example, a removable storage unit 622 and an interface 620. Examples of such means may include a program cartridge and cartridge interface (such as that found in video game devices), a removable memory chip (such as EPROM, or PROM) and associated socket, and other removable storage units 622 and interfaces 620 which allow software and data to be transferred from the removable storage unit 622 to computer system 600.

Computer system 600 may also include a communications interface 624. Communications interface 624 allows software and data to be transferred between computer system 600 and external devices. Communications interfaces 624 may include a modem, a network interface (such as an Ethernet card), a communications port, a PCMCIA slot and card, or the like. Software and data transferred via communications interface 624 may be in the form of signals, which may be electronic, electromagnetic, optical, or other signals capable of being received by communications interface 624. These signals may be provided to communications interface 624 via a communications path 626.

In this document, the terms “computer program storage medium” and “computer usable storage medium” are used to generally refer to storage media such as removable storage unit 618, removable storage unit 622, and a hard disk installed in hard disk drive 612. Computer program storage medium and computer usable storage medium may also refer to memories, such as main memory 608 and secondary memory 610, which may be memory semiconductors (e.g. DRAMS, etc.).

Computer programs (also called computer control logic) are stored in main memory 608 and/or secondary memory 610. Computer programs may also be received via communications interface 624. Such computer programs, when executed, enable computer system 600 to implement embodiments as discussed herein. In particular, the computer programs, when executed, enable processor device 604 to implement the processes of the disclosure, such as the stages in the method illustrated by flowcharts 200 and 400 of FIGS. 2 and 4 discussed above. Accordingly, such computer programs represent controllers of the computer system 600. When an embodiment is implemented using software, the software may be stored in a computer program product and loaded into computer system 600 using removable storage drive 614, interface 620, and hard disk drive 612, or communications interface 624.

### CONCLUSION

The foregoing description of the specific embodiments will so fully reveal the general nature of the present invention that others may, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not limitation, such that the terminology or phraseology of the specification is to be interpreted by the skilled artisan in light of the teachings and guidance.

Therefore, embodiments consistent with the invention may be used to provide a system of automatically changing wallpaper images that are displayed by a computing device to a user with a single engagement with a single icon also displayed by the computing device. In many embodiments, this may permit the user to bypass a series of steps required by the operating system of the computing device to manually change the wallpaper images that are displayed.

The breadth and scope of the present invention should not be limited by any of the above-described exemplary embodiments, but should be defined only in accordance with the claims and their equivalents.

What is claimed is:

1. A computing device, comprising:
a user interface configured to display a single icon that is associated with automatically changing a wallpaper image displayed by the user interface;
at least one processor; and
program code configured for execution by the at least one processor to:
receive a single input from a user when the user engages the single icon displayed via the user interface to automatically change the wallpaper image displayed by the user interface, and
replace a current wallpaper image that is displayed by the user interface with a updated wallpaper image when the single input from the user is received.

2. The computing device of claim 1, wherein program code is further configured to select the updated wallpaper image from a plurality of wallpaper images previously installed on the computing device when the single input from the user is received.

3. The computing device of claim 2, wherein the program code is further configured to randomly select the updated wallpaper image from the plurality of wallpaper images previously installed on the computing device.

4. The computing device of claim 3, wherein the program code is further configured to randomly select the updated wallpaper image from the plurality of wallpaper images previously installed on the computing device based on a number associated with the updated wallpaper image that is generated by a random number generator.

5. The computing device of claim 2, wherein the plurality of wallpaper images is stored in a wallpaper image database.

6. The computing device of claim 2, wherein the user interface is further configured to display at least a subset of the plurality of wallpaper images stored in the wallpaper image database when an access input from the user and directed to the single icon is received requesting to access the plurality of wallpaper images.

7. The computing device of claim 6, wherein the program code is further configured to:
after displaying wallpaper images in response to the access input, add an image to the wallpaper image database when an add input from the user is received such that the image is available to be selected when the single input from the user is received.

8. The computing device of claim 6, wherein the program code is further configured to differentiate the single input from the access input based on how the user engaged the single icon when the user generated the single input as opposed to when the user engaged the single icon to generate the access input.

9. The computing device of claim 8, wherein the program code is further configured to associate a single input engagement generated by the user when engaging the single icon with the single input and associate an access input engagement generated by the user when engaging the single icon with the access input.

10. The computing device of claim 9, wherein the single input comprises a short touch directed to the single icon and the access input comprises a long touch directed to the single icon.

11. A method of automatically changing a wallpaper image that is displayed via a user interface of a computing device, comprising:
displaying a single icon via the user interface that is associated with automatically changing the wallpaper image displayed by the user interface;
receiving a single input from a user when the user engages the single icon displayed via the user interface to automatically change the wallpaper image displayed by the user interface; and
replacing a current wallpaper image that is displayed by the user interface with an updated wallpaper image when the single input from the user is received.

12. The method of claim 11, further comprising:
selecting the updated wallpaper image from a plurality of wallpaper images previously installed on the computing device when the single input from the user is received.

13. The method of claim 12, further comprising:
randomly selecting the updated wallpaper image from the plurality of wallpaper images previously installed on the computing device.

14. The method of claim 13, further comprising:
randomly selecting the updated wallpaper image from the plurality of wallpaper images previously installed on the computing device based on a number associated with the updated wallpaper image that is generated by a random number generator.

15. The method of claim 12, wherein the plurality of wallpaper images is stored in a wallpaper image database.

16. The method of claim 12, further comprising:
displaying at least a subset of the plurality of wallpaper images stored in the wallpaper image database when an access input from the user and directed to the single icon is received requesting to access the plurality of wallpaper images.

17. The method of claim 12, further comprising:
after displaying wallpaper images in response to the access input, adding an image to the wallpaper image database when an add input from the user is received such that the image is available to be selected when the single input from the user is received.

18. The method of claim 16, further comprising:
differentiating the single input from the access input based on how the user engaged the single icon when the user generated the single input as opposed to when the user engaged the single icon to generate the access input.

19. The method of claim 18, further comprising:
associating a single input engagement generated by the user when engaging the single icon with the single input; and
associating an access input engagement generated by the user when engaging the single icon with the access input.

20. The method of claim 19, wherein the single input comprises a short touch directed to the single icon and the access input comprises a long touch directed to the single icon.

21. A program product, comprising:
a non-transitory computer readable storage medium; and
program code stored on the non-transitory computer readable storage medium and configured for execution by at least one processor to automatically change a wallpaper image that is displayed via a user interface of a computing device by:
displaying a single icon via the user interface that is associated with automatically changing the wallpaper image displayed by the user interface;
receiving a single input from a user when the user engages the single icon displayed via the user interface to automatically change the wallpaper image displayed by the user interface; and
replacing a current wallpaper image that is displayed by the user interface with an updated wallpaper image when the single input from the user is received.
